(19) United States
(12) Patent Application Publication
(10) Pub. No.: US 2001/0050306 A1
(43) Pub. Date: Dec. 13, 2001

(54) Folding ballot box

(76) Inventor: Richard George Plumb, Far Forest (GB)

Correspondence Address: John P. McMahon, 524 Redman Avenue, Haddonfield, NJ, 08033, US

(21) Appl. No.: 09/789,381

(22) Filed: Feb. 23, 2001

(30) Foreign Application Priority Data
Jun. 13, 2000 (GB) 0014152.3

(51) Int. Cl. G07C 13/02

(52) U.S. Cl. 232/2

(57) ABSTRACT

A reusable folding ballot box having walls, a base and a lid with an aperture therein for the insertion of ballot papers. The walls, base and lid are provided by a flexible bag-like outer member enclosing reinforcing means rearrangeable from a folded position into an erected position to maintain the ballot box in its erected configuration. The aperture in the lid has guide means associated therewith constructed and arranged to maintain the ballot paper in a substantially horizontal orientation during its initial passage through the aperture. The cover can be a hinged lid or a slidable cover.

This invention relates to a folding ballot box.

Conventional ballot boxes are usually formed from metal and are provided with a hinged lid in which there is a slot for allowing ballot papers to be inserted. The size of a ballot box is determined by the maximum number of ballot papers which it would be required to receive. Since ballot boxes are in use for only a very limited amount of time, there is a significant problem associated with their storage. This problem is particularly acute in the case of democratic societies, such as country, unitary and local authorities, parliamentary constituencies and parish councils and trade unions, which are required by their constitutions to hold ballots as part of their decision making process. Such societies are often of limited means and the space required to store a suitable number of ballot boxes can be a drain on resources, resulting from increased property rental charges, etc.

The volume of space occupied by ballot boxes also makes it commercially unrewarding for a firm to provide a ballot box rental service. The cost of suitable warehousing would result in the rental charges being higher than the market could stand. Furthermore the weight and volume of conventional ballot boxes can present transport problems. Also, the sharp edges and angular construction of known ballot boxes have health and safety implications for ballot administrators.

Collapsible boxes are known but these are generally for packaging purposes and therefore not suitable for use as ballot boxes as they are not constructed in a way that would enable them to provide the required level of security.

U.S. Pat. No. 1,673,769 discloses a reusable folding ballot box comprising a container having walls, a base and a lid and having a slit therein for the insertion of ballot papers. However, because this ballot box is made of metal it is expensive to manufacture. It is also heavy which means that it is not particularly convenient for the user to handle and furthermore, when stored, special shelving will be required to carry the considerable weight of the metal ballot boxes stored thereon.

Canadian Patent No. 1118734 discloses a disposable ballot box constructed into an erected condition. This box however is only intended to be used once and discarded after use so it is intentionally not a very rugged construction. Neither does it provide a particularly high level of security.

The applicant overcame these problems by designing the foldable ballot box covered by the European Patent No. 0542821 which comprises a container having walls, a base and a lid with a slit therein for the insertion of ballot papers, the walls, base and lid being provided by a flexible bag-like outer member enclosing reinforcing means rearrangable from a collapsed position into an erected position to maintain the ballot box in its erected configuration, the slit having reinforcing means associated therewith.

In the preferred embodiment, the slit was provided in the lid and the ballot papers would be inserted in a vertical plane through the lid to fall into the ballot box. A problem with this construction was that the ballot papers would not always fall in a regular manner to form a uniform stack so time had to be spent reorganising them into a uniform stack before they could be counted. Furthermore, if electronic readers were to be used to check the ballot papers, they would also need to be rearranged so that they were all orientated in the same direction. This sorting was found to be very time consuming.

It is therefore an object of the invention to overcome or substantially reduce these problems by providing a reusable ballot box which is rugged and secure in construction and which can be stored in a flat planar condition but erected when required for use and which can be used repeatedly.

According to one aspect of the invention, there is provided a reusable folding ballot box comprising a container having walls, a base and a lid with an aperture therein for the insertion of ballot papers, the walls, base and lid being provided by a flexible bag-like outer member enclosing reinforcing means rearrangable from a folded position into an erected position to maintain the ballot box in its erected configuration, the aperture having guide means associated therewith to maintain the ballot paper in a substantially horizontal orientation during its initial passage through the aperture.

The reinforcing means preferably comprises a plurality of stiff panels and each wall of the ballot box has one of said panels associated therewith.

Preferably, the walls comprise a front wall, a rear wall, two side walls and the panels associated with said side walls are displaceable relative thereto.

The displaceable panels are preferably hingeably mounted such that they can be displaced to lie flat against said front and rear walls respectively.

In the preferred embodiment, the aperture is provided with closure means operable to close said aperture.

In the preferred embodiment, the aperture is formed in a rigid member which is secured to the lid of the ballot box, the guide means comprising an inclined ramp or chute having a distal end which is spaced from the underside of said rigid member to define said aperture through which a ballot paper can be inserted into the ballot box in a substantially horizontal orientation.

The bottom of the chute can be planar or curved across its width.

The aperture is preferably closed by a movable cover. In one embodiment, the cover is a hinged lid. Alternatively, it can be a slidable cover.

According to another aspect of the invention, there is provided a reusable ballot box comprising a flexible bag-like outer member comprising walls, a base and a lid, said outer member enclosing therein reinforcing means rearrangable from a folded collapsed configuration to an erected configuration, an insert in the outer member having an aperture therein configured to admit a ballot paper to the interior of the ballot box in a substantial horizontal orientation, an obturator movable from a first position in which the aperture is open to a second position in which the aperture is closed and releasable locking means associated therewith to retain said obturator in its closed and/or open positions. Preferably, the releasable locking means is accessible only from the underside of the lid when the ballot box has been opened to remove the contents therefrom.

Embodiments of the present invention will now be described, by way of example only, with reference to the accompanying drawings, in which:

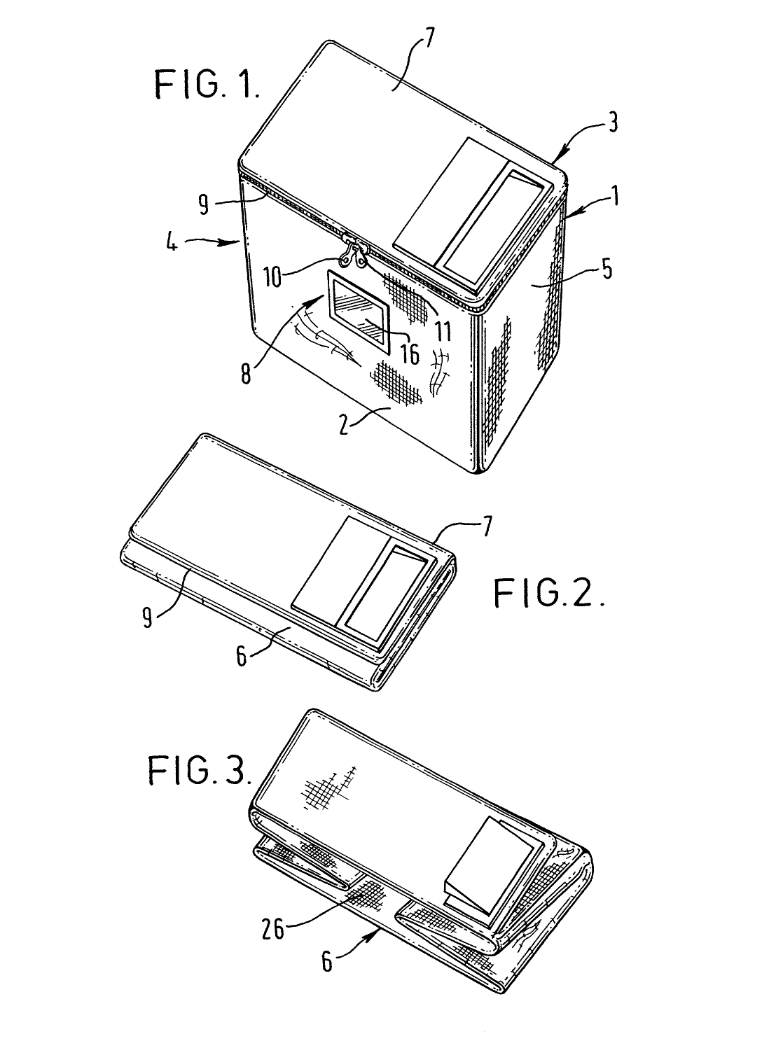

FIG. 1 shows one form of reusable ballot box according to the present invention in its erect condition;

FIG. 2 shows the reusable ballot box of FIG. 1 in its folded condition;

FIG. 3 shows the underside of the lid of the ballot box shown in FIGS. 1 and 2 and the ballot box in an intermediate folded condition;

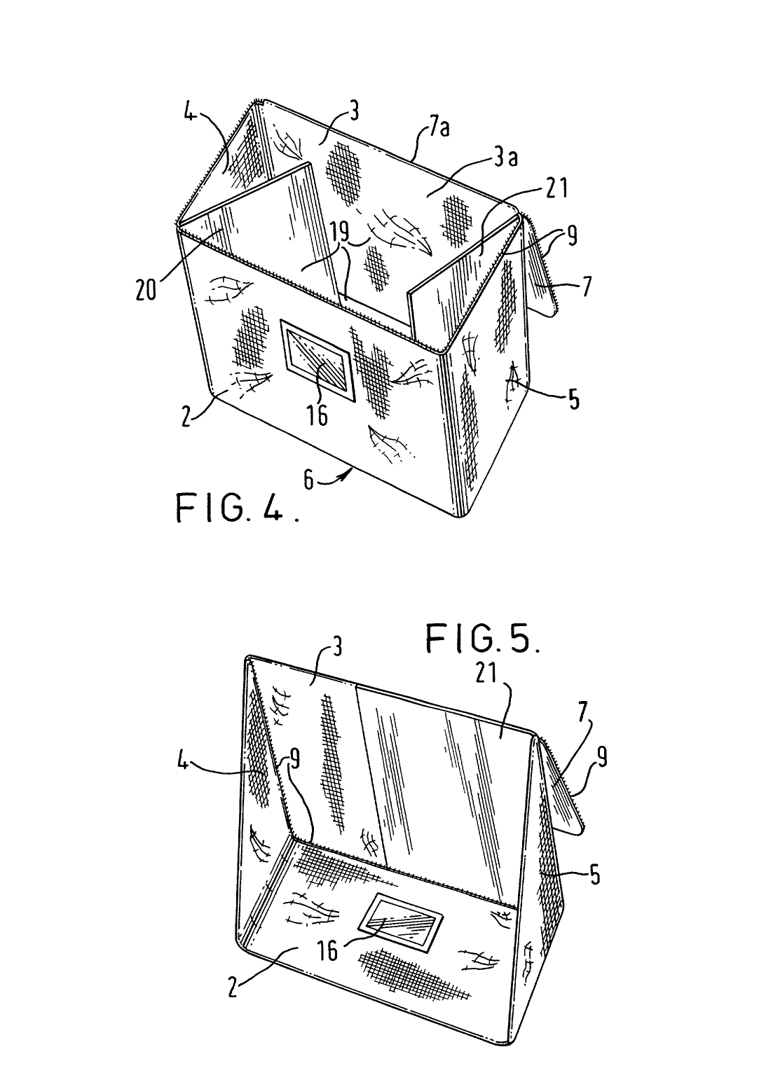

FIGS. 4 and 5 show the reusable ballot box of the present invention at various stages in its disassembly intermediate those shown in FIGS. 1-3;

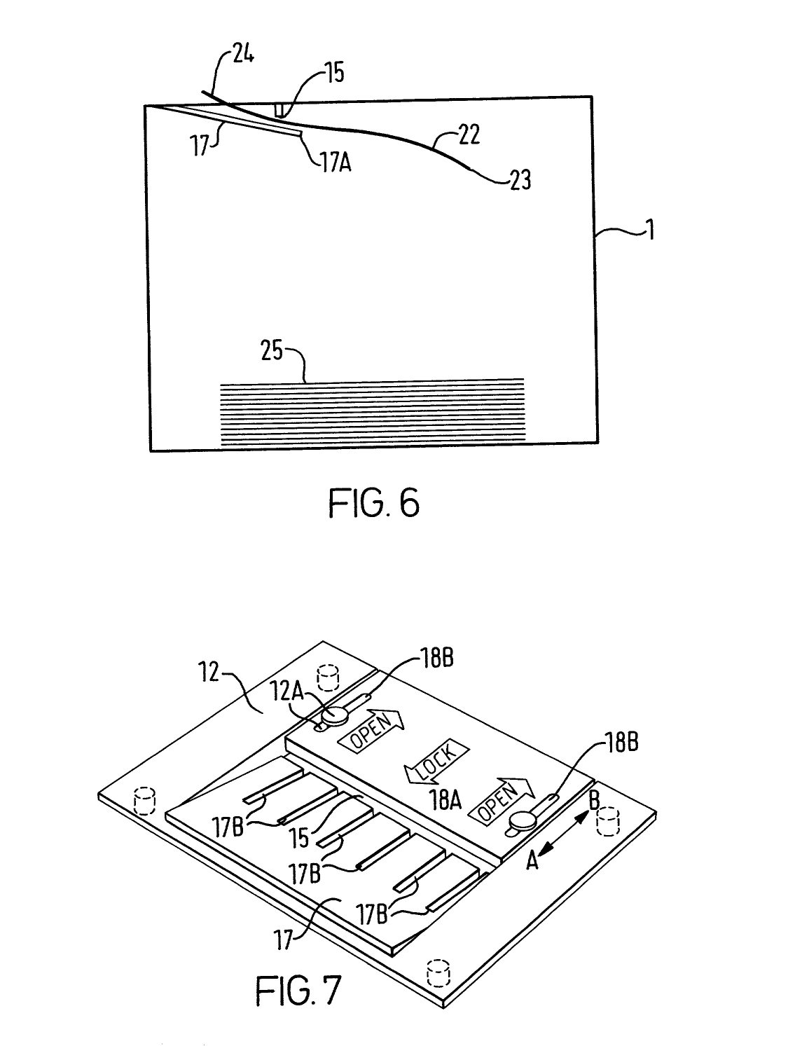

FIG. 6 is a schematic view showing the interior of the ballot box with a ballot paper being inserted therein;

FIG. 7 shows an alternative form of entry slot with a slidable cover for fitting to the ballot box lid;

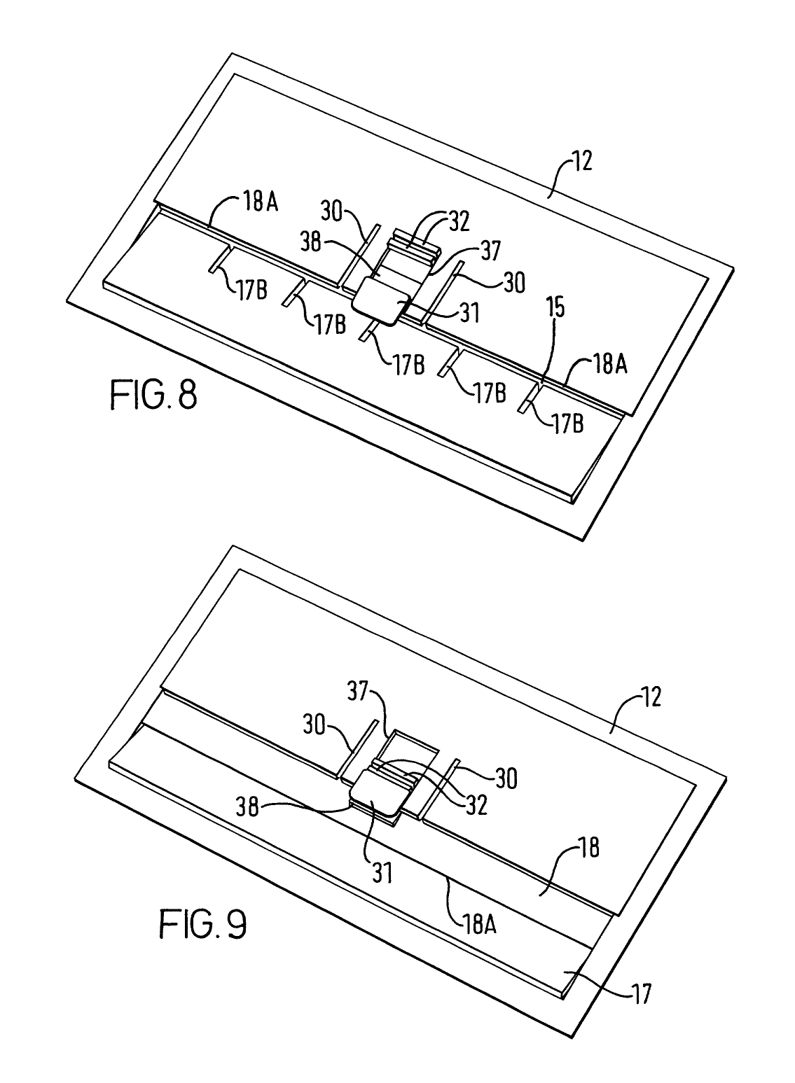

FIG. 8 shows a further alternative form of entry slot assembly with a lockable sliding cover in its open position;

FIG. 9 shows the entry slot assembly of FIG. 8 with the cover in its closed position;

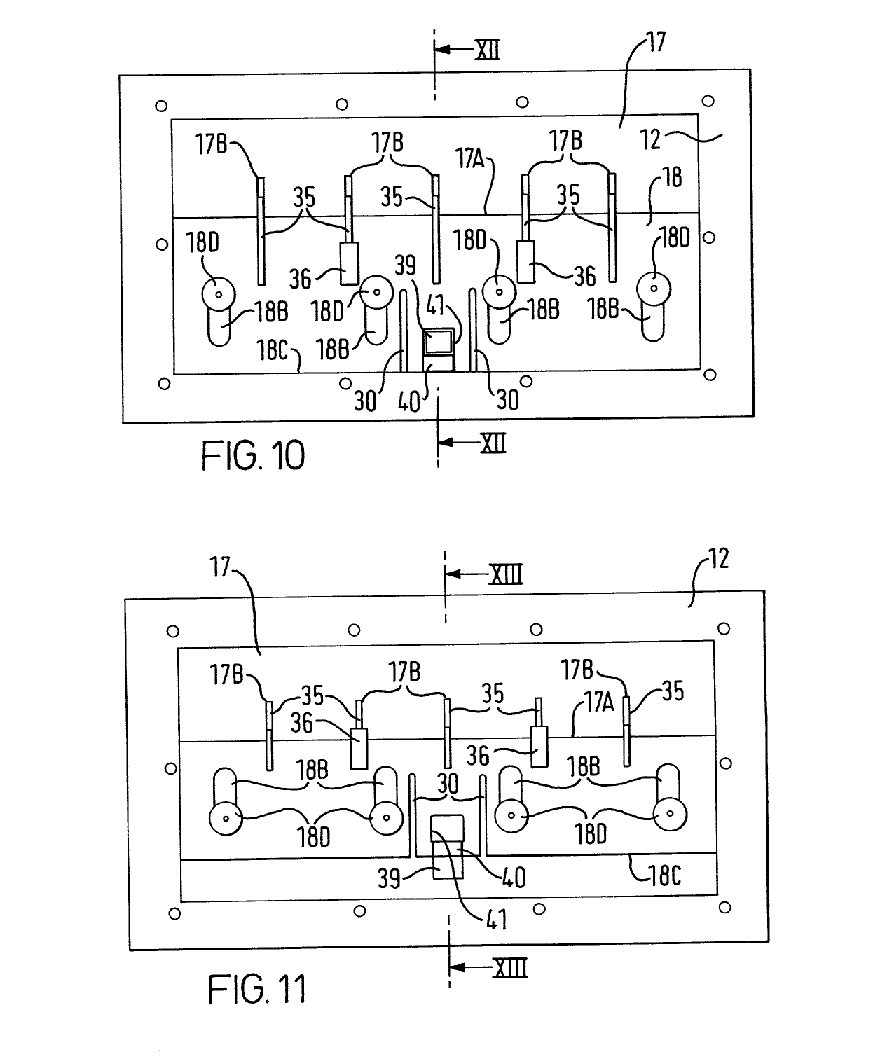

FIG. 10 is an underside view of the entry slot assembly of FIG. 8;

FIG. 11 is an underside view of the entry slot assembly of FIG. 9;

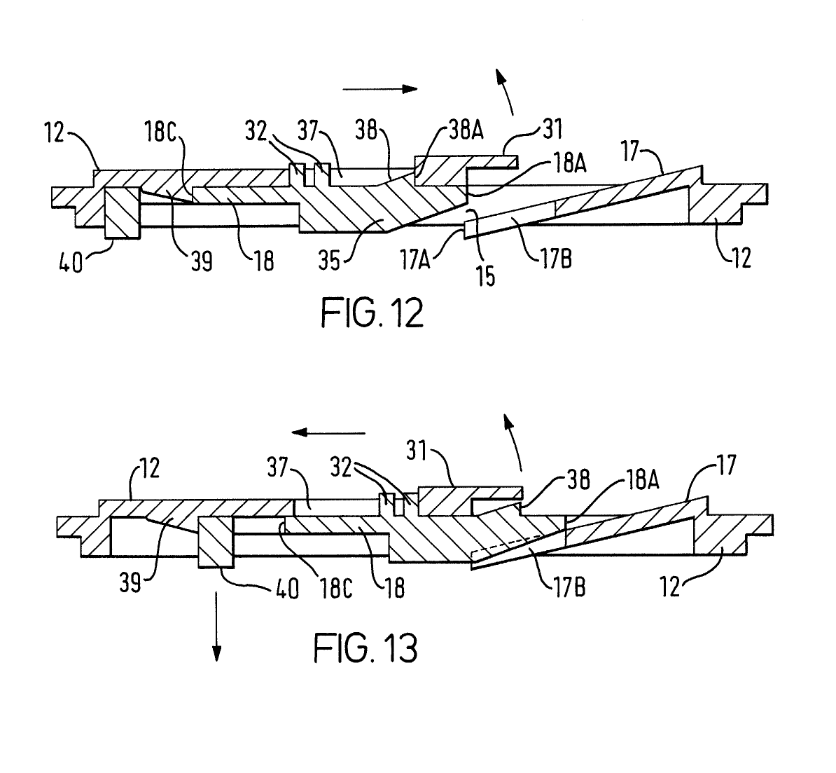

FIG. 12 is a cross section along the line XII-XII in FIG. 10; and

FIG. 13 is a cross section along the line XII-XII in FIG. 11.

Referring to FIG. 1, there is shown a reusable ballot box 1 comprising a front wall 2, a rear wall 3, first and second side walls 4,5, a base 6 and a lid 7, all formed from a flexible sheet material, such as a synthetic-fibre textile. The ballot box maintains its erected shape shown in FIG. 1 by the incorporation of reinforcing members associated with the respective walls of the box. An open box-like lower portion 8 is formed by five walls 2,3,4,5,6 and is joined along the upper margin 3a of the rear wall 3 to the rear margin 7a of the closure member, or lid 7. The lid 7 covers the entire opening of the lower portion 8 and is maintained in that position by fastening means such as a zip 9 which unites the three free margins of the lid 7 with respective upper margins of the side walls 4,5 and the front wall 2. The zip 9 includes two sliding tabs 10,11 which are arranged so that each can be used to fasten a portion of the zip 9. When the zip 9 has been completely done up, the tabs 10,11 are adjacent each other and can be coupled by means of a padlock or security ties or cable ties (not shown) which can be passed through holes provided therein.

The lid 7 is provided with a horizontal aperture or slot 15 through which ballot papers may be inserted substantially horizontally into the ballot box. The slot 12 is closable by hinged cover 13.

The construction of the slot 15 formed in the lid 7 will now be described in more detail. As can be seen in FIGS. 1-3 and 6, a rigid frame member 12 has guide means in the form of a downwardly sloping chute 17 formed therein. The chute 12 has a distal end 17A which is spaced below the plane of the rigid frame member 12 to form the slot 15. The distal end 17A of the chute 17 can be located beyond the vertical plane of the slot 15 to extend into the interior of the ballot box for a short distance beyond the rigid frame 12 (see FIG. 3) for reasons which will be explained shortly.

The rigid frame member 12 and chute 17 are preferably made of a moulded rigid plastics material and the cover 13 is attached to the frame to pivot about hinge 14 in the direction of the arrow. Preferably the cover 13 and rigid frame member 12 have cooperating parts (not shown) which engaged and align with each other when the lid is closed, each part having a hole in it which will align with a corresponding hole in the other part so that a padlock can be passed through the aligned holes in the cooperating parts to lock and secure the lid 13 to the rigid member 12 in known manner.

An alternative slot assembly is shown in FIG. 7 which comprises a rigid frame member 12 having guide means in the form of a downwardly inclined chute or ramp 17 formed therein which terminates in a horizontal slot 15. Parallel slots 17B are formed in the chute 17 across the width thereof. A slidable cover 18 with a front face 18A is mounted on the frame 12 and acts as an obturator to close the slot 15. Pegs 12A protrude upwardly from the rigid frame 12 through slots 18B and the cover 18 is slidable along slots 18B in the direction of arrow A-B. In the illustrated condition, the slot 15 is open so a ballot paper can be inserted through it into the ballot box. However, if the cover 18 is slid forwardly in the direction of arrow A, corresponding ribs or fingers (not shown) extending from the underside of the cover 18 enter the slots 17B as the lid 18 is moved in the direction of arrow A. The bottom edge of the front face 18A of the cover 18 eventually engages with the inclined ramp 17 so the slot 15 no longer exist and is therefore fully closed. Because the fingers (not shown) are now fully inserted in the slots 17B, it is not possible to gain unauthorised access to the interior of the ballot box by using a knife blade or similar implement inserted laterally into the slot 15 as the upstanding fingers prevent this. Some or all of the fingers (not shown) preferably also have means such as abutments on them which engage with the underside of the ramp 17 on either side of the slots 17B to prevent the cover 18 being prised upwardly using a knife or blade. The cover or obturator 18 preferably also includes means (not shown) which retain it in its open or closed position. These can comprise engaging parts e.g. ramps and abutment surfaces which allow the cover 18 to automatically lock when it is moved into its closed position. This can be achieved by providing a projection on the underside of the cover 18 which engages in a hole in the frame 12 when it reaches its fully closed position, this projection only being releasable from the underside of the cover 18 to which access can only be gained when the ballot box is unlocked by removing the padlock from the tabs 10,11 on the zip 9.

Referring now to FIG. 6, it can be seen that when a ballot paper 22 is inserted into the slot 15, (a ballot paper can be 18-24″ long), it is initially maintained in a generally horizontal disposition by the guide means or chute 17 until its distal end 22 drops down into the bottom of the ballot box to form stack 25. This is important because otherwise the ballot paper might twist and remain upstanding in the interior of the ballot box thereby reducing the capacity of the box or preventing the complete insertion of the next ballot paper into it. It will be appreciated that this novel entry system for the ballot papers ensures that they always fall uniformly into stack 25 in the same orientation so no further manual sorting should be necessary and the stack 25 can be lifted out of the box 1 and fed immediately into known electronic reading equipment without the need for any further time consuming work.

FIGS. 8-13 show a still further type of entry slot assembly similar to that shown in FIG. 7 and, where possible, the same reference numerals have been used.

The entry slot assembly comprises a rigid frame or body 12 having a horizontal slot 15 formed therein and a ramp or chute 17 leading down to the entry slot. A plurality of parallel slots 17B are formed in the chute 17. The top of the body 12 has an aperture 37 formed in it and a slot 30 or each side thereof. A tab 31 protrudes upwardly from the top of the body 12 at the front end of the aperture 37. Due to the slits 30, the tab 31 can be flexed and lifted upwardly for reasons to be explained hereafter.

A cover or obturator 18 is slidably mounted in the body 12 and has a projection 32 which extends from its upper surface to protrude upwardly through the hole 37 in the body. A ramp or cam 38 is also formed on the upper surface of the slidable cover 18 and spaced from the projection 32. As can be seen from FIGS. 8,10 and 12, when the cover 18 is in its open position, the projection 32 abuts the rear edge of the hole 37 and the front edge 38A of the cam 38 engages with the front edge of the aperture 37. In this position, the slot 15 is open and a ballot paper can be inserted through it.

To close the slidable cover or obturator 18 to its position showing FIGS. 9, 11 and 13, the tab 31 has to be lifted upwardly as indicated by the arrow so that the front edge of the hole 37 clears the front face 38A of the cam 38. The cover 18 can then be slid forwardly until its front edge 18A abuts the inclined chute 17 thereby closing the slit 15 (see FIG. 9). Once the projection 32 has engaged the rear face of the front of the aperture 37, and the cam 38 is located beneath the tab 31, the front face of a second cam 39 locates against the rear edge 17C of the cover 18. As a result, the cover is now locked in its closed position shown in FIGS. 11 and 13. As can be seen, fingers 35 locate in the slots 17B and feet 36 slide over the rear edge 17A of the chute 17. Thus, the cover 18 cannot be prised apart from the chute 17 and the slot 15 is securely closed.

To open the cover 18 and reopen the slot 15, post 40 (see FIGS. 10-13) has to be lifted so that the rear edge 18C of the cover 18 clears the second cam 39 and the cover 18 can be slid back until the second cam 39 locates in hole 45 in the cover 18 adjacent the post 40 as shown in FIG. 10. As this happens, the tab 31 rides up the cam 38 until it locates against the front face 38A thereof as shown in FIGS. 8 and 12 to lock the cover in its open position.

It will be appreciated that because the post 40 is located on the underside of the cover 18, it can only be accessed when the ballot box has been opened so security is excellent, when the cover is closed. Furthermore, the fingers 35 which locate in the slots 17B and the feet 36 riding over the rear edge 17A of the chute prevent unauthorised entry or access through the slot 15.

A transparent plastics window 16 is located on the outer surface of the front wall of the ballot box 1, behind which a card may be placed. Such a card may carry information concerning the location of the ballot box. Additionally, a legend such as “BALLOT BOX” may be imprinted on the top surface of the ballot box.

FIG. 4 shows the reusable ballot box 1 with the lid 7 open and folded back. Within the ballot box 1 are reinforcing means in the form of three fixed reinforcing members 19, associated with the base 6, the rear wall 3 and the front wall 2 respectively. Fourth and fifth reinforcing members 20,21 are associated with respective side walls 4,5. Fourth reinforcing member 20 is hingeable mounted in a corner defined by the intersection of the rear wall 3 and the second side wall 5. The reinforcing members are formed from cardboard, though they could equally well be formed from a light metal such as aluminium.

A method of collapsing or folding the reusable ballot box 1, shown in FIG. 1, will now be described. Firstly, the zip 9 having removed the padlock (not shown) from the tabs 10,11, the zip 9 can be undone and the lid 7 folded back. This allows any ballot papers within the ballot box 1 to be removed. The hingeably mounted reinforcing members 20,21 (see FIG. 4) can then be displaced about their hinges so that they lie flat against the front and rear walls 2,3 respectively.

Referring to FIG. 5, the front wall 2 is folded into the lower portion 8 and comes to rest overlying the base 6. The side walls 4,5 have been folded in on themselves by this action to form the illustrated triangular end shapes. Inward pressure applied to the side walls 4,5 will now cause the back wall 3 to fold down onto the front wall 2, as shown in FIG. 5. The lid 7 can now be wrapped around the open end 23 of the folded ballot box 1 and its free end restrained by means of the press stud portions 18A cooperating with complementary structures on the outer surface of the base.

It is envisaged that other folding arrangements or fastening means may be employed.

The reusable ballot box of the present invention has a number of advantages over conventional ballot boxes. Its reduced weight and size means that it is readily transportable. The nature of its construction means that it is durable, i.e. it will not rust nor is there any paint to peel, and it can conveniently be produced in a wide range of colours etc. suitable for diverse applications. It also has the advantage over known disposable ballot boxes that it can be reused and provides greater security due to the combination of the flexible outer bag-like member and the collapsible reinforcing panels associated therewith. With the known disposable cardboard ballot box, access to the contents of the box can easily be achieved.

The foldable ballot box can be made from flame retardant materials if required.

1. A reusable folding ballot box comprising a container having walls, a base and a lid with an aperture therein for the insertion of ballot papers, the walls, base and lid being provided by a flexible bag-like outer member enclosing reinforcing means rearrangeable from a folded position into an erected position to maintain the ballot box in its erected configuration, the aperture having guide means associated therewith to maintain the ballot paper in a substantially horizontal orientation during its initial passage through the aperture.

2. A ballot box as claimed in claim 1 wherein the reinforcing means is a plurality of stiff panels and each wall of the ballot box has one of said panels associated therewith.

3. A ballot box as claimed in claim 1 wherein the walls comprise a front wall, a rear wall, two side walls and the panels associated with said side walls are displaceable relative thereto.

4. A ballot box as claimed in claim 3 wherein the displaceable panels are hingeably mounted such that they can be displaced to lie flat against said front and rear walls respectively.

5. A ballot box as claimed in claim 1 wherein the aperture is formed in a rigid member which is secured to the lid of the ballot box, the guide means comprising an inclined ramp or chute having a distal end which is spaced from the underside of said rigid member to define said aperture through which a ballot paper can be inserted into the ballot box in a substantially horizontal orientation.

6. A ballot box as claimed in claim 1 wherein the aperture is closed by a movable cover.

7. A ballot box as claimed in claim 6 wherein the cover is a hinged lid.

8. A ballot box as claimed in claim 6 wherein the cover is slidable.

9. A reusable ballot box comprising a flexible bag-like outer member comprising walls, a base and a lid, said outer member enclosing therein reinforcing means rearrangeable from a folded collapsed configuration to an erected configuration, an insert in the outer member having an aperture therein configured to admit a ballot paper to the interior of the ballot box in a substantial horizontal orientation, an obturator movable from a first position in which the aperture is open to a second position in which the aperture is closed and releasable locking means associated therewith to retain said obturator in its closed and/or open positions.

10. A ballot box as claimed in claim 11 wherein the releasable locking means is accessible only from the underside of the lid when the ballot box has been opened to remove the contents therefrom.
